(19) United States
(12) Patent Application Publication
(10) Pub. No.: US 2020/0005767 A1
(43) Pub. Date: Jan. 2, 2020

(54) INFORMATION PROCESSING METHOD, APPARATUS AND STORAGE MEDIUM

(71) Applicant: BAIDU ONLINE NETWORK TECHNOLOGY (BEIJING) CO., LTD., Beijing (CN)

(72) Inventors: Jingyu YE, Beijing (CN); Mengmeng ZHANG, Beijing (CN); Zhongji FAN, Beijing (CN); Li WAN, Beijing (CN); Liuhui ZHANG, Beijing (CN)

(21) Appl. No.: 16/564,122

(22) Filed: Sep. 9, 2019

(30) Foreign Application Priority Data
Nov. 1, 2018 (CN) 201811293274.9

(51) Int. Cl. G10L 15/08; G10L 13/00; G06F 17/27; G06F 9/54

(52) U.S. Cl. CPC G10L 15/08; G06F 9/542; G06F 17/2705; G10L 13/00

(57) ABSTRACT

Embodiments of the present disclosure provide an information processing method, apparatus, and storage medium. The method includes: performing speech recognition processing on a received target speech signal to obtain a speech recognition result; searching for information whose matching degree with the speech recognition result is greater than a preset threshold and setting the information as target information if the speech recognition result is not matched to any information; and notifying a user of the target information, thereby providing a new solution for processing information to offer more services with enhanced intelligence to the user.

### CROSS-REFERENCE TO RELATED APPLICATION

This application claims priority to Chinese Patent Application No. 201811293274.9, filed on Nov. 1, 2018, which is hereby incorporated by reference in its entirety.

### TECHNICAL FIELD

Embodiments of the present disclosure relate to the information processing technology, and in particular, to an information processing method, apparatus, and storage medium.

### BACKGROUND

With the continuous development of information processing technology, intelligent devices are featuring more and more types and functions, such as intelligent speakers. An intelligent device typically recognizes a user's speech, and then performs subsequent processing according to the recognized speech information, for example, information recommendation including contents such as songs, videos, and the like.

An existing intelligent device will, when the user's statement is vague, or when the intelligent device cannot find any information that matches the current speech, enter a resultless state, thus harming the user experience.

### SUMMARY

Embodiments of the present disclosure provide an information processing method, apparatus and storage medium to provide users with more services with enhanced intelligence.

In a first aspect, an embodiment of the present disclosure provides an information processing method, including:
performing speech recognition processing on a received target speech signal to obtain a speech recognition result;
searching for information whose matching degree with the speech recognition result is greater than a preset threshold and setting the information as target information if the speech recognition result is not matched to any information; and notifying a user of the target information.

In a possible design, the searching for information whose matching degree with the speech recognition result is greater than a preset threshold and setting the information as target information includes:
extracting a keyword in the speech recognition result; and
searching for information whose matching degree with the keyword is greater than the preset threshold and setting the information as the target information.

In a possible design, the searching for information whose matching degree with the keyword is greater than the preset threshold and setting the information as the target information includes:
searching in different functions for information whose matching degree with the keyword is greater than the preset threshold and setting the information as a first result; and determining, in the first result, a preset quantity of information as the target information according to a matching degree.

In a possible design, the determining, in the first result, a preset quantity of information as the target information according to a matching degree includes: determining, in the first result, information with the highest matching degree as the target information.

In a possible design, the searching for information whose matching degree with the keyword is greater than the preset threshold and setting the information as the target information includes:
determining a function to be searched according to the keyword;
searching, in the function to be searched, for information whose matching degree with the keyword is greater than the preset threshold and setting the information as a second result; and determining, in the second result, information with the highest matching degree as the target information.

In a possible design, the notifying a user of the target information includes:
determining a type of speech from text-to-speech (TTS) according to the target information; and
playing the target information in a form of voice for the user by using the type of speech through an audio playback device.

In a possible design, the searching for information whose matching degree with the keyword is greater than the preset threshold and setting the information as the target information includes:
determining at least one function to be searched according to the keyword;
searching in the at least one function to be searched for information whose matching degree with the keyword is greater than the preset threshold and setting the information as a third result; and determining, in the third result, a preset quantity of information as the target information according to a matching degree.

In a possible design, the notifying a user of the target information includes:
displaying the target information for the user through a display device.

In a possible design, after the notifying a user of the target information, the method further includes:
receiving a playback instruction from the user, the playback instruction being used to specify target information to be played; and
playing the target information corresponding to the playback instruction.

In a second aspect, an embodiment of the present disclosure provides an information processing apparatus, including:
a processing module, configured to perform speech recognition processing on a received target speech signal to obtain a speech recognition result; and search for information whose matching degree with the speech recognition result is greater than a preset threshold and set the information as target information if the speech recognition result is not matched to any information; and
a notifying module, configured to notify a user of the target information.

In a possible design, when searching for information whose matching degree with the speech recognition result is greater than a preset threshold and set the information as target information, the processing module is specifically configured to:
extract a keyword in the speech recognition result; and
search for information whose matching degree with the keyword is greater than the preset threshold and set the information as the target information.

In a possible design, when searching for information whose matching degree with the keyword is greater than the preset threshold and set the information as the target information, the processing module is specifically configured to:
search in different functions for information whose matching degree with the keyword is greater than the preset threshold and set the information as a first result; and
determine, in the first result, a preset quantity of information as the target information according to a matching degree.

In a possible design, when determining, in the first result, a preset quantity of information as the target information according to a matching degree, the processing module is specifically configured to: determine, in the first result, information with the highest matching degree as the target information.

In a possible design, when searching for information whose matching degree with the keyword is greater than the preset threshold and set the information as the target information, the processing module is specifically configured to:
determine a function to be searched according to the keyword;
search, in the function to be searched, for information whose matching degree with the keyword is greater than the preset threshold and set the information as a second result; and
determine, in the second result, information with the highest matching degree as the target information.

In a possible design, the notifying module is specifically configured to:
determine a type of speech from text-to-speech (TTS) according to the target information; and
play the target information in a form of voice for the user by using the type of speech through an audio playback device.

In a possible design, when searching for information whose matching degree with the speech recognition result is greater than a preset threshold and setting the information as target information, the processing module is specifically configured to:
determine at least one function to be searched according to the keyword;
search in the at least one function to be searched for information whose matching degree with the keyword is greater than the preset threshold and set the information as a third result; and
determine, in the third result, a preset quantity of information as the target information according to a matching degree.

In a possible design, the notifying module is specifically configured to: display the target information for the user through a display device.

In a possible design, the apparatus further includes: a receiving module, configured to receive a playback instruction from a user after the notifying module notifies the user of the target information, where the playback instruction is used to specify target information to be played; and correspondingly, the notifying module is further configured to play the target information corresponding to the playback instruction.

In a third aspect, an embodiment of the present disclosure provides an information processing apparatus, including: a processor and a memory, where the memory is used to store computer executable instructions, and the processor executes the computer executable instructions to cause the processor to perform any one of the information processing methods according to the first aspect.

In a fourth aspect, an embodiment of the present disclosure provides a computer readable storage medium having stored thereon computer executable instructions that, when executed by a processor, causes any one of the information processing methods according to the first aspect to be implemented.

In the information processing method, apparatus and storage medium according to the embodiment of the present disclosure, performing speech recognition processing on a received target speech signal to obtain a speech recognition result; searching for information whose matching degree with the speech recognition result is greater than a preset threshold and setting the information as target information if the speech recognition result is not matched to any information; and notifying a user of the target information, thereby providing a new solution for processing information to provide more services with enhanced intelligence to the user.

### BRIEF DESCRIPTION OF THE DRAWINGS

In order to more clearly illustrate the technical solutions in the embodiments of the present application or in the prior art, a brief introduction to the drawings used for describing the embodiments or the prior art will be made below. Obviously, the drawings in the following description show some embodiments of the present disclosure, and those skilled in the art may still derive other drawings from these drawings without paying any creative effort.

FIG. 1 is a flowchart of an information processing method according to an embodiment of the present disclosure;

FIG. 2 is a flowchart of an information processing method according to another embodiment of the present disclosure;

FIG. 3 is a schematic structural diagram of an information processing apparatus according to an embodiment of the present disclosure;

FIG. 4 is a schematic structural diagram of an information processing apparatus according to another embodiment of the present disclosure; and

FIG. 5 is a schematic structural diagram of an information processing apparatus according to still another embodiment of the present disclosure.

### DESCRIPTION OF EMBODIMENTS

To make the purposes, technical solutions and advantages of the embodiments of the present application clearer, the technical solutions in the embodiments of the present application will be clearly and completely described below with reference to the drawings in the embodiments of the present application. Apparently, the described embodiments are some but not all of the embodiments according to the present application. All other embodiments obtained by a person of ordinary skill in the art based on the embodiments of the present application without making creative efforts shall fall within the protection scope of the present application.

Firstly, it is clear that an intelligent device in an embodiment of the present disclosure may include, but is not limited to, an intelligent speaker, an intelligent robot, and other terminals having a speech recognition function and/or performing operations such as audio/video playback on the basis of speech recognition.

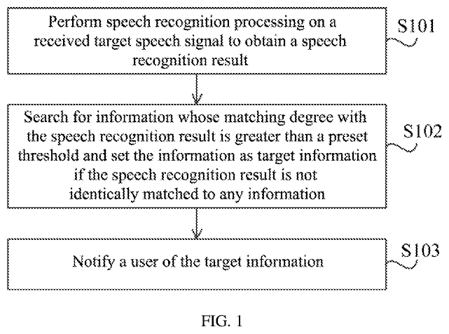

FIG. 1 is a flowchart of an information processing method according to an embodiment of the present disclosure. The embodiment of the present disclosure provides an information processing method, and the execution body of the information processing method may be an information processing apparatus, and the information processing apparatus may be implemented by software/hardware meanings. In an actual application, the information processing apparatus may be a standalone device, such as an intelligent device or a server; or the information processing apparatus may be integrated into another intelligent device or server, and exists as a part of the intelligent device or server, and the existence form of the information processing apparatus is not limited in the present disclosure.

In an actual application, when the information processing apparatus is a server, an connection between the server and an intelligent device such as an intelligent speaker is established for information interaction, where the intelligent device such as an intelligent speaker receives a speech signal and transmits the speech signal to the server, so that the server performs the information processing method according to the embodiment of the present disclosure. Afterwards, the server transmits target information obtained according to the speech signal to an intelligent device such as an intelligent speaker, so as to enable the intelligent device such as the intelligent speaker to notify the user of the target information.

As shown in FIG. 1, the information processing method includes:

S101, perform speech recognition processing on a received target speech signal to obtain a speech recognition result.

Specifically, the target speech signal is received, speech recognition processing is performed on the target speech signal to obtain the speech recognition result. The target speech signal refers to the currently processed speech signal. Generally, the target speech signals corresponding to different moments are different. The speech recognition result is usually in the form of text, i.e., the speech recognition processing converts the target speech signal from a speech form to a text form.

The speech recognition technology used in the speech signal processing is not limited in the embodiment of the present disclosure, and it can be any technology that can recognize speech.

After obtaining the speech recognition result corresponding to the target speech signal, the information processing apparatus runs the speech recognition result through an information storage module, such as a database, to look for a match. If the speech recognition result is matched to some information, the information matching the speech recognition result is notified to the user. Otherwise, the information processing apparatus executes step S102. Optionally, the same information as the speech recognition result is presented in a text form.

Exemplary, when the user speaks with an accent, the speech of the user as recognized by the intelligent speaker may be different from the intended meaning of the user. Considering what is stored in the information storage module such as the database is usually in a standard language, such as Mandarin, it may happen that a match for the recognized speech of the user could not be found in the information storage module such as the database.

Then, the information processing apparatus executes S102.

S102, search for information whose matching degree with the speech recognition result is greater than a preset threshold and set the information to be target information if the speech recognition result is not matched to any information is not matched.

It can be understood that, if the same information as the speech recognition result does not exist, unlike the case of a conventional intelligent device, which enters a resultless state, the information processing apparatus in the embodiment of the present disclosure continues to search for information having a relatively high matching degree with the speech recognition result and treats it as the target information. For example, information whose matching degree with the speech recognition result is greater than a preset threshold or the like is treated as the target information. The preset threshold can be set according to historical experience or an actual situation, the value thereof is not limited in the embodiment of the present disclosure.

For example, if the speech recognition result is “feng da sheng yin” and the information processing apparatus fails to find any information matching with the “feng da sheng yin” in the information storage module such as the database, it will continue the search until the information whose matching degree with the “feng da sheng yin” is greater than the preset threshold is found: “fang da sheng yin”, and use the “fang da sheng yin” as the target information.

There is a certain connection between the speech recognition result and the information whose matching degree with the speech recognition result is greater than the preset threshold, and the connection may be presented as an overall speech error correction or an overall semantic error correction, etc., where the overall semantic error correction may include a name correction. For example, the overall semantic error correction of the “Song of Zhong Xue You” may result in “Song of Zhang Xue You”, etc.

In addition, the information whose matching degree with the speech recognition result is greater than a preset threshold is not limited to full-text information whose matching degree with the speech recognition result is greater than a preset threshold. Rather, it may also be information whose matching degree with some of the keywords in the speech recognition result is greater than the preset threshold, this may be the case that will be explained in the following embodiments and will not yet be elaborated herein.

S103, notify a user of the target information.

There may be one or more target information. The term “more” includes two pieces or more than two pieces. In a design, when there is a plurality pieces of target information, the first target information is notified to the user by default.

Optionally, the target information is notified to the user in a preset format. For example, the target information is “Song of Zhang Xue You”, and the information processing apparatus will notify the user of “Do you want “Song of Zhang Xue You”?”, or “Did you mean “Song of Zhang Xue You”?”, etc.

In some embodiments, if the information processing apparatus executes S103, notifies the user of the target information, and no further instruction is received for a preset time period, the content referred to by the target information is played for the user. For example, Zhang Xue You's song is played for the user.

Alternatively, optionally, the information processing apparatus may notify the user of a resource or a resource list or a resource link or the like corresponding to the target information.

It is to be noted that examples in the embodiments of the present disclosure are merely for ease of understanding, and are not to be construed as limitations.

The specific form used to notify the user of the target information can be an audio form or a video form. For example, for an intelligent device that has an audio playback function rather than a display function, the target information can be played for the user through the audio playback device in the intelligent device; for an intelligent device that has a display function rather than an audio playback function, the target information can be displayed for the user through the display device in the intelligent device; and for an intelligent device having both the display function and the audio playback function, the target information can be displayed for the user through the display device in the intelligent device, and can be played for the user through the audio playback device in the intelligent device.

The present embodiment performs speech recognition processing on a received target speech signal to obtain a speech recognition result; searches for information whose matching degree with the speech recognition result is greater than a preset threshold and sets the information as target information if the speech recognition result is not matched to any information; and then notifies the user of the target information, thereby providing a new solution for processing information to provide more services with enhanced intelligence for the user.

Next, an explanation will be given to the case where the information whose matching degree with the speech recognition result is greater than a preset threshold is set to be the information whose matching degree with some of the keywords in the speech recognition result is greater than the preset threshold.

In this case, in a possible implementation, the searching for information whose matching degree with the speech recognition result is greater than the preset threshold and setting the information as the target information is greater than the preset threshold may include: extracting a keyword in the speech recognition result; searching for information whose matching degree with the keyword is greater than the preset threshold and setting the information as the target information. The keyword may be at least one of the following entities:
1) a resource name, for example, a video resource name (such as a movie title, a TV drama title), a song name, an audio resource name, etc.;
2) a name of a person, for example, a name of a popular public figure such as a star, a director, and a scientist;
3) a proper noun, for example, Bitcoin, World Cup, Hong Kong-Zhuhai-Macao Bridge, etc.;
4) a name of an animal, such as a fox, dolphin, dinosaur, etc.;
or the like.

In a possible design, the searching for information whose matching degree with the keyword is greater than the preset threshold and setting the information as the target information may include: searching in different functions for information whose matching degree with the keyword is greater than the preset threshold and setting the information as a first result; determining, in the first result, a preset quantity of information as the target information according to a matching degree. The functions may be, for example, video, music, audio, encyclopedia, etc. Optionally, when the playback device is an audio playback device, the function to be searched for is a function corresponding to an audio resource, for example, audio, music, etc. Alternatively, when the playback device is a display device, the function to be searched for is a function corresponding to a video resource, for example, encyclopedia, video, etc.

Optionally, when the playback device is an audio playback device, in a first possible implementation, the determining, in the first result, a preset quantity of information as the target information according to a matching degree may include: determining, in the first result, information with the highest matching degree as the target information. Correspondingly, the notifying a user of the target information may include: determining a type of speech from text-to-speech (TTS) according to the target information; playing the target information in a form of voice for the user by using the type of speech through an audio playback device. In this embodiment, the information processing apparatus is an intelligent device having an audio playback function. Or the information processing apparatus may be a server which transmits the target information to the intelligent device having an audio playback function.

In a second possible implementation, the searching for information whose matching degree with the keyword is greater than a preset threshold and setting the information as target information may include: determining a function to be searched according to the keyword; searching, in the function to be searched, for information whose matching degree with the keyword is greater than the preset threshold and setting the information as a second result; determining, in the second result, information with the highest matching degree as the target information. Correspondingly, the notifying the user of the target information may include: determining a type of speech from text-to-speech TTS according to the target information; playing the target information in a form of voice for the user by using the type of speech through an audio playback device. In this embodiment, the information processing apparatus is an intelligent device having an audio playback function. Or, the information processing apparatus may be a server which transmits the target information to an intelligent device having an audio playback function.

The difference between this implementation and the first possible implementation lies in that the first possible implementation first searches in different functions for information whose matching degree with the keyword is greater than the preset threshold and sets the information as the first result, and then determines, in the first result, a preset quantity of information as the target information, while the second possible implementation first determines the function to be searched according to the keyword, and then searches, in the function to be searched, for information whose matching degree with the keyword is greater than the preset threshold and set the information as a second result, and determines, in the second result, information with the highest matching degree as the target information.

Illustratively, the above type of speech may be:
[Music] I didn't fully understand it, but I found some music contents related to the {keyword}. May I play them for you?
[Audio] I didn't fully understand it, but I found some broadcast contents related to the {keyword} for you. May I play them for you?
[Encyclopedia] I didn't fully understand it, but I found related introductions to the {keyword} for you. May I play them for you?

Optionally, when the playback device is a display device, in an implementation, the searching for information whose matching degree with the keyword is greater than the preset threshold and setting the information as the target information may include: searching in different functions for information whose matching degree with the keyword is greater than the preset threshold and setting the information as a first result; determining, in the first result, a preset quantity of information as the target information according to a matching degree. Correspondingly, the notifying a user of the target information may include: displaying the target information for the user through a display device. In this embodiment, the information processing apparatus may be an intelligent device having a display function; or the information processing apparatus may be a server which transmits the target information to an intelligent device having a display function.

In another implementation, the searching for information whose matching degree with the keyword is greater than the preset threshold and setting the information as the target information may include: determining at least one function to be searched according to the keyword; searching in the at least one function to be searched for information whose matching degree with the keyword is greater than the preset threshold and setting the information as a third result; determining, in the third result, a preset quantity of information as the target information according to a matching degree. Correspondingly, the notifying the user of the target information may include: displaying the target information for the user through the display device. In this embodiment, the information processing apparatus may be an intelligent device having a display function; or the information processing apparatus may be a server which transmits the target information to an intelligent device having a display function.

The difference between this implementation and the above implementation is that one implementation first searches in different functions for information whose matching degree with the keyword is greater than the preset threshold and sets the information as the first result, and then determines, in the first result, a preset quantity of information as the target information according to a matching degree. Instead, this implementation first determines the at least one function to be searched according to the keyword, and then searches in the determined at least one function to be searched for information whose matching degree with the keyword is greater than the preset threshold and set the information as a third result, and determines, in the third result, information with the highest matching degree as the target information according to matching degrees.

The value of the preset number in the above two implementations may be set according to historical experience or actual conditions. For example, the preset number may be 3 or 4. Optionally, when the actual number of the information whose matching degree with the keyword is greater than the preset threshold is less than the preset number, only the actual number of target information will be determined.

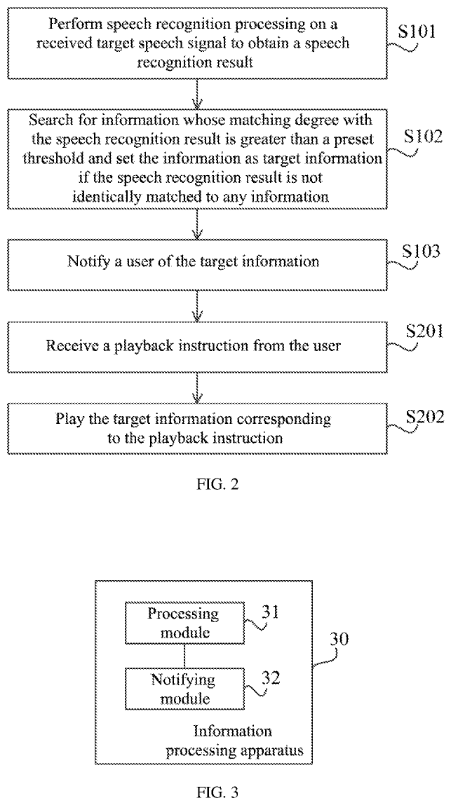

FIG. 2 is a flowchart of an information processing method according to another embodiment of the present disclosure. The information processing apparatus in this embodiment is an intelligent device having a display function. Referring to FIG. 2, on the basis of the embodiment shown in FIG. 1, after notifying the user of the target information in S103, the information processing method in this embodiment may further include:

S201, receive a playback instruction from the user.

The playback instruction is configured to specify target information to be played.

S202, play the target information corresponding to the playback instruction.

For example, the playback instruction may be an affirmative answer such as “playback”, “OK”. At this time, when there is one piece of target information, the information processing apparatus displays the content of the resource corresponding to the target information. Or, when there are a plurality pieces of target information, the information processing apparatus by default displays the content of the resource corresponding to the target information arranged in the first place among the plurality pieces of target information. Or, when there are a plurality pieces of target information, after displaying the plurality pieces of target information for the user through the display device, the information processing apparatus accepts a selection from the user to play the content of the resource corresponding to one of the target information. For example, the user may say “play the x^{th} target information”, and correspondingly, the information processing apparatus plays, through the display device, the x^{th} target information or the content of its corresponding resource.

### Example I

An intelligent device end TTS, i.e., an intelligent device, plays through an audio playback device (for example, a speaker): I didn't fully understand it, but I found some contents related to the {keyword}, which one do you want to play?

At the same time, the intelligent device displays through a display device: guess you may want the content related to the “keyword”: content 1, content 2, etc.

When the user gives an affirmative answer such as “do play it”, “OK”, the content of the resource corresponding to the first target information is displayed.

If the user says something otherwise, exit the playback.

The following is an apparatus embodiment of the present disclosure, which can be used to implement the above method embodiments.

FIG. 3 is a schematic structural diagram of an information processing apparatus according to an embodiment of the present disclosure. The embodiment of the disclosure provides an information processing apparatus, which can be implemented by software and/or hardware. For a detailed description of the information processing apparatus, reference may be made to the above method embodiments, which will not be repeated herein.

As shown in FIG. 3, an information processing apparatus 30 includes a processing module 31 and a notifying module 32, where:
the processing module 31 is configured to perform speech recognition processing on a received target speech signal to obtain a speech recognition result; and search for information whose matching degree with the speech recognition result is greater than a preset threshold and set the information as target information if the speech recognition result is not matched to any information; and
the notifying module is configured to notify a user of the target information.

The information processing apparatus provided in the present embodiment performs speech recognition processing on a received target speech signal to obtain a speech recognition result; searches for information whose matching degree with the speech recognition result is greater than a preset threshold and sets the information as target information if the speech recognition result is not matched to any information; and notifies a user of the target information, thereby providing a new solution for processing information to provide more services with enhanced intelligence for the user.

Optionally, when searching for information whose matching degree with the speech recognition result is greater than a preset threshold and setting the information as target information, the processing module 31 may be specifically configured to: extract a keyword in the speech recognition result; search for information whose matching degree with the keyword is greater than the preset threshold and set the information as the target information.

Further, when searching for information whose matching degree with the keyword is greater than the preset threshold and setting the information as the target information, the processing module 31 may be specifically configured to: search in different functions for information whose matching degree with the keyword is greater than the preset threshold and set the information as a first result; determine, in the first result, a preset quantity of information as the target information according to a matching degree.

Further, when determining, in the first result, a preset quantity of information as the target information according to a matching degree, the processing module 31 may be specifically configured to: determine, in the first result, information with the highest matching degree as the target information.

In another implementation, when searching for information whose matching degree with the keyword is greater than a preset threshold and setting the information as the target information, the processing module 31 may be specifically configured to: determine a function to be searched according to the keyword; search, in the function to be searched, for information whose matching degree with the keyword is greater than the preset threshold and set the information as a second result; and determine, in the second result, information with the highest matching degree as the target information.

On the above basis, the notifying module 32 may be specifically configured to: determine a type of speech from text-to-speech (TTS) according to the target information; and play the target information in a form of voice for the user by using the type of speech through an audio playback device.

In another implementation, when searching for information whose matching degree with the keyword is greater than the preset threshold and setting the information as the target information, the processing module 31 may be specifically configured to: determine at least one function to be searched according to the keyword; search in the at least one function to be searched for information whose matching degree with the keyword is greater than the preset threshold and set the information as a third result; and determine, in the third result, a preset quantity of information as the target information according to a matching degree.

Optionally, the notifying module 32 may be specifically configured to: display the target information for the user through a display device.

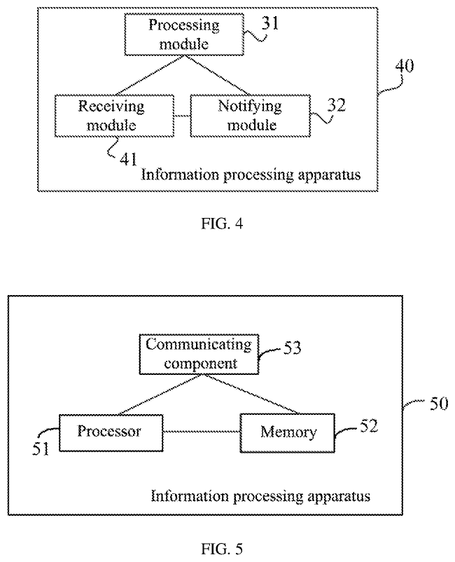

FIG. 4 is a schematic structural diagram of an information processing apparatus according to another embodiment of the present disclosure. Referring to FIG. 4, on the basis of the structure shown in FIG. 3, the information processing apparatus 40 may further include: a receiving module 41. The receiving module 41 is configured to receive a playback instruction from the user after the notifying module 32 notifies the user of the target information. The playback instruction is used to specify target information to be played. Correspondingly, the notifying module 32 may also be used to play the target information corresponding to the playback instruction.

FIG. 5 is a schematic structural diagram of an information processing apparatus according to still another embodiment of the present disclosure. As shown in FIG. 5, the information processing apparatus 50 includes:
at least one processor 51 and a memory 52, where:
the memory 52 stores computer executable instructions; and
the at least one processor 51 executes the computer executable instructions stored in the memory 52 to enable the at least one processor 51 to execute any one of the above method embodiments.

For a specific implementation process of the processor 51, reference may be made to the above method embodiments. The implementation principles and technical effects thereof are similar, and will not be repeated herein.

Optionally, the information processing apparatus 50 further includes a communication component 53. The processor 51, the memory 52, and the communicating component 53 are connected to each other. The information processing apparatus 50 may perform information interaction with a server or other devices through the communicating component 53.

An embodiment of the present embodiment further provides a computer readable storage medium having stored thereon computer executable instructions that, when executed by the processor, cause the information processing method as described above to be implemented.

In the above embodiments, it should be understood that the disclosed devices and methods may be implemented in other manners. For example, the device embodiments described above are merely illustrative. For example, the division of the modules is only based on their logical functions, and there may be other division manner in actual implementation. For example, multiple modules may be combined or may be integrated into another system, or some features may be ignored or not executed. In addition, the mutual coupling or direct coupling or communication connection shown or discussed may be an indirect coupling or communication connection through some interface, apparatus or module, and may be in an electrical form, mechanical form or in other forms.

The modules described as separate components may or may not be physically separated, and the components displayed as modules may or may not be physical units. That is, the modules may be located in one place, or may be distributed throughout multiple network units. Some or all of the modules may be selected according to actual needs to achieve the purpose of the solution of the present embodiment.

In addition, functional modules in embodiments of the present disclosure may be integrated into one processing unit, or exist as physically separated modules, or two or more modules may be integrated into one unit. A unit integrating the above modules may be implemented in the form of hardware or in the form of hardware plus software functional units.

The integrated module described above implemented in the form of a software functional module may be stored in a computer readable storage medium. The above software functional module is stored in a storage medium and includes instructions for causing a computer device (which may be a personal computer, a server, or a network device, etc.) or a processor to perform some of the steps of the methods according to the various embodiments of the present application.

It should be understood that the processor may be a Central Processing Unit (CPU), or may be other general-purpose processors, a Digital Signal Processor (DSP), an Application Specific Integrated Circuit (ASIC), etc. The general-purpose processor may be a microprocessor, or the processor may be any conventional processor or the like. Steps of the method disclosed with reference to the present disclosure may be directly implemented by a hardware processor, or may be performed by a combination of hardware and software modules in the processor.

The memory may include a high speed RAM memory, and may also include a non-volatile memory (NVM), such as at least one disk storage, and may also be a USB thumb, a removable hard disk, a read only memory, a magnetic disk, or an optical disk.

A bus may be an Industry Standard Architecture (ISA) bus, a Peripheral Component (PCI) bus, or an Extended Industry Standard Architecture (EISA) bus. The bus can be divided into an address bus, a data bus, a control bus, and the like. For ease of description, the bus in the drawings of the present application is not limited to only one bus or one type of bus.

The above storage medium may be implemented by any type of volatile or non-volatile storage device or by a combination thereof, such as static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk. The storage medium may be any available media that can be accessed by a general purpose or special purpose computer.

An exemplary storage medium is coupled to the processor to enable the processor to read information from, and write information to, the storage medium. Of course, the storage medium may also be an integral part of the processor. The processor and the storage medium may be located in an application specific integrated circuit (ASIC). Of course, the processor and the storage medium may also exist as discrete components in a terminal or a server.

One of ordinary skill in the art will appreciate that all or some of the steps to implement the various method embodiments described above may be completed by hardware associated with the program instructions. The program may be stored in a computer readable storage medium. The program, when executed, performs the steps including the above various method embodiments; and the storage medium includes various media, such as a ROM, a RAM, a magnetic disk, or an optical disk, that may store program codes.

Finally, it should be noted that the above embodiments are merely illustrative of the technical solutions of the present disclosure, and are not to be taken in a limiting sense. Although the present disclosure has been described in detail with reference to the above embodiments, those skilled in the art will understand that they may still modify the technical solutions described in the above embodiments, or equivalently substitute some or all of the technical features, and the modifications or substitutions do not deviate the nature of the corresponding technical solutions from the range of the technical solutions of the embodiments of the present disclosure.

What is claimed is:

1. An information processing method, comprising:
performing speech recognition processing on a received target speech signal to obtain a speech recognition result;
searching for information whose matching degree with the speech recognition result is greater than a preset threshold and setting the information as target information if the speech recognition result is not matched to any information; and
notifying a user of the target information.

2. The method according to claim 1, wherein the searching for information whose matching degree with the speech recognition result is greater than a preset threshold and setting the information as target information comprises:
extracting a keyword in the speech recognition result; and
searching for information whose matching degree with the keyword is greater than the preset threshold and setting the information as the target information.

3. The method according to claim 2, wherein the searching for information whose matching degree with the keyword is greater than the preset threshold and setting the information as the target information comprises:
searching in different functions for information whose matching degree with the keyword is greater than the preset threshold and setting the information as a first result; and
determining, in the first result, a preset quantity of information as the target information according to a matching degree.

4. The method according to claim 3, wherein the determining, in the first result, a preset quantity of information as the target information according to a matching degree comprises:
determining, in the first result, information with the highest matching degree as the target information.

5. The method according to claim 2, wherein the searching for information whose matching degree with the keyword is greater than the preset threshold and setting the information as the target information comprises:
determining a function to be searched according to the keyword;
searching, in the function to be searched, for information whose matching degree with the keyword is greater than the preset threshold and setting the information as a second result; and
determining, in the second result, information with the highest matching degree as the target information.

6. The method according to claim 4, wherein the notifying a user of the target information comprises:
determining a type of speech from text-to-speech (TTS) according to the target information; and
playing the target information in a form of voice for the user by using the type of speech through an audio playback device.

7. The method according to claim 5, wherein the notifying a user of the target information comprises:
determining a type of speech from text-to-speech (TTS) according to the target information; and
playing the target information in a form of voice for the user by using the type of speech through an audio playback device.

8. The method according to claim 2, wherein the searching for information whose matching degree with the keyword is greater than the preset threshold and setting the information as the target information comprises:
determining at least one function to be searched according to the keyword;
searching in the at least one function to be searched for information whose matching degree with the keyword is greater than the preset threshold and setting the information as a third result; and
determining, in the third result, a preset quantity of information as the target information according to a matching degree.

9. The method according to claim 3, wherein the notifying a user of the target information comprises:
displaying the target information for the user through a display device.

10. The method according to claim 8, wherein the notifying a user of the target information comprises:
displaying the target information for the user through a display device.

11. The method according to claim 1, wherein after the notifying a user of the target information, the method further comprises:
receiving a playback instruction from the user, the playback instruction being used to specify target information to be played; and
playing the target information corresponding to the playback instruction.

12. An information processing apparatus, comprising: a processor and a memory, wherein
the memory is configured to store computer executable instructions; and
the processor is configured to execute the computer executable instructions to:
perform speech recognition processing on a received target speech signal to obtain a speech recognition result;
search for information whose matching degree with the speech recognition result is greater than a preset threshold and set the information as target information if the speech recognition result is not matched to any information; and
notify a user of the target information.

13. The information processing apparatus according to claim 12, wherein the processor is further configured to:
extract a keyword in the speech recognition result; and
search for information whose matching degree with the keyword is greater than the preset threshold and set the information as the target information.

14. The information processing apparatus according to claim 13, wherein the processor is further configured to:
search in different functions for information whose matching degree with the keyword is greater than the preset threshold and set the information as a first result; and
determine, in the first result, a preset quantity of information as the target information according to a matching degree.

15. The information processing apparatus according to claim 14, wherein the processor is further configured to:
determine, in the first result, information with the highest matching degree as the target information.

16. The information processing apparatus according to claim 13, wherein the processor is further configured to:
determine a function to be searched according to the keyword;
search, in the function to be searched, for information whose matching degree with the keyword is greater than the preset threshold and set the information as a second result; and
determine, in the second result, information with the highest matching degree as the target information.

17. The information processing apparatus according to claim 15, wherein the processor is further configured to:
determine a type of speech from text-to-speech (TTS) according to the target information; and
play the target information in a form of voice for the user by using the type of speech through an audio playback device.

18. The information processing apparatus according to claim 12, wherein the processor is further configured to:
determine at least one function to be searched according to the keyword;
search in the at least one function to be searched for information whose matching degree with the keyword is greater than the preset threshold and set the information as a third result; and
determine, in the third result, a preset quantity of information as the target information according to a matching degree.

19. The information processing apparatus according to claim 13, wherein the processor is further configured to:
display the target information for the user through a display device.

20. A computer readable storage medium, storing thereon computer executable instructions that, when being executed by a processor, causes the method according to claim 1 to be implemented.
